(19) United States
(12) Patent Application Publication
(10) Pub. No.: US 2011/0037245 A1
(43) Pub. Date: Feb. 17, 2011

(54) Compass prayer book

(76) Inventor: Isaac Kairey, Eatontown, NJ (US)

Correspondence Address: Isaac Kairey, 17 Valley Forge Road, Eatontown, NJ, 07724, US

(21) Appl. No.: 12/583,213

(22) Filed: Aug. 17, 2009

(51) Int. Cl. B42D 3/12

(52) U.S. Cl. 281/15.1; 281/29

(57) ABSTRACT

The Compass Prayer Book is an invention which combines a book with a directional device, for example, a compass. It is uniquely designed to allow a reader to precisely determine the direction one wishes to face toward when one is reading a book. What is new is the ease and specificity, and certainty that a user will gain in determining the specific direction he or she wishes to face towards when using a book, or a prayer book. The user will have no doubt. What is also new is that the user will have no doubt as to being able to determine the direction one wishes to face while reading. When the user is in possession of the Compass Prayer Book, by definition, the user will have both a book and a directional device at the user's disposal, in one unique entity.

### CROSS REFERENCE TO RELATED APPLICATIONS

Not Applicable

### STATEMENT REGARDING FEDERALLY SPONSORED RESEARCH OF DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

A reader has an issue as to which direction to face when reading. People of certain religious faiths are required to face in a given direction when reading their prayer books. Other readers wish to determine direction of sunlight for reading, or tanning when reading, or the avoidance of direct sunlight, or direction of light for reading, or to determine sunrise or sunset eventualities, and a plethora of other desires. The Compass Prayer Book combines two common entities into a whole that is greater and more unique than the sum of its two parts. Containing a Prayer Book or a secular book with a compass embedded in a book allows a user the convenience of one entity to both read and determine the desired direction that the reader wishes to face. The specific problem of determining direction is solved with this new entity, the Compass Prayer Book. The Compass Prayer Book need not be a “Prayer” book.

Some readers of certain religious faiths have historically had the problem of determining what direction to face while reading religious literature. This specific problem is solved with the Compass Prayer Book.

Secular readers have traditionally found it difficult to determine desired direction that the reader wishes to face while reading. The Compass Prayer Book solves that problem

### BRIEF SUMMARY OF THE INVENTION

The Compass Prayer Book is an entity that allows a user to predetermine the direction the reader wishes to face when reading. For religious purposes, prayer book readers have struggled for centuries to determine the specific direction one should face when reading their daily or other prayers. Secular readers are constantly shifting and changing direction, as they plan for optimal reading light, tanning, avoiding direct sunlight, etc.

With the Compass Prayer Book, a compass is embedded into the book itself allowing for a swift and easy determination of direction for the reader. At times the reader may have a book but be unable to determine desired direction for reading. In other instances, the reader may know direction, but not have the desired book.

With the Compass Prayer Book, the user of this invention will always have both the book and the means to determine direction to face while reading. This is a tremendous advantage to those seeking to read and face toward a specific direction. It solves the previously existing problems of either having a means to determine direction, but having no book, or having a book, but no means to determine direction.

As examples, the Muslim faith and Jewish faith disciples often pray daily, sometimes several times per day, and during special services, events, and ceremonies, and, are required, by their faith, to face in a specific direction when reading or reciting from their prayer books. Over one billion people, just from these two specific examples will benefit greatly from the uniqueness, convenience, and gestalt of the Compass Prayer Book. The user of the Compass Prayer Book easily, swiftly, and conveniently, are in possession of both a book and a directional device embedded in that book, forming a unique entity, the Compass Prayer Book, enabling the user to determine direction one wishes to face while reading, while in addition having the book at their disposal. For these users the ancient problem of determining direction, and having the means of determining direction available to them at all times (the directional device is embedded in the book) is a new paradigm, and is instantly recognized as such by those familiar with this common problem.

The object of the invention of the Compass Prayer Book is to allow a reader to have at his or her disposal, guaranteed, a book with a directional device to determine the direction one wishes to face while reading.

### BRIEF DESCRIPTION OF THE SEVERAL VIEWS OF THE DRAWING

FIG. 1A: Compass Prayer Book. A prayer book, in English, with a compass embedded in its front cover. Compass may be embedded in any part of the Compass Prayer Book.

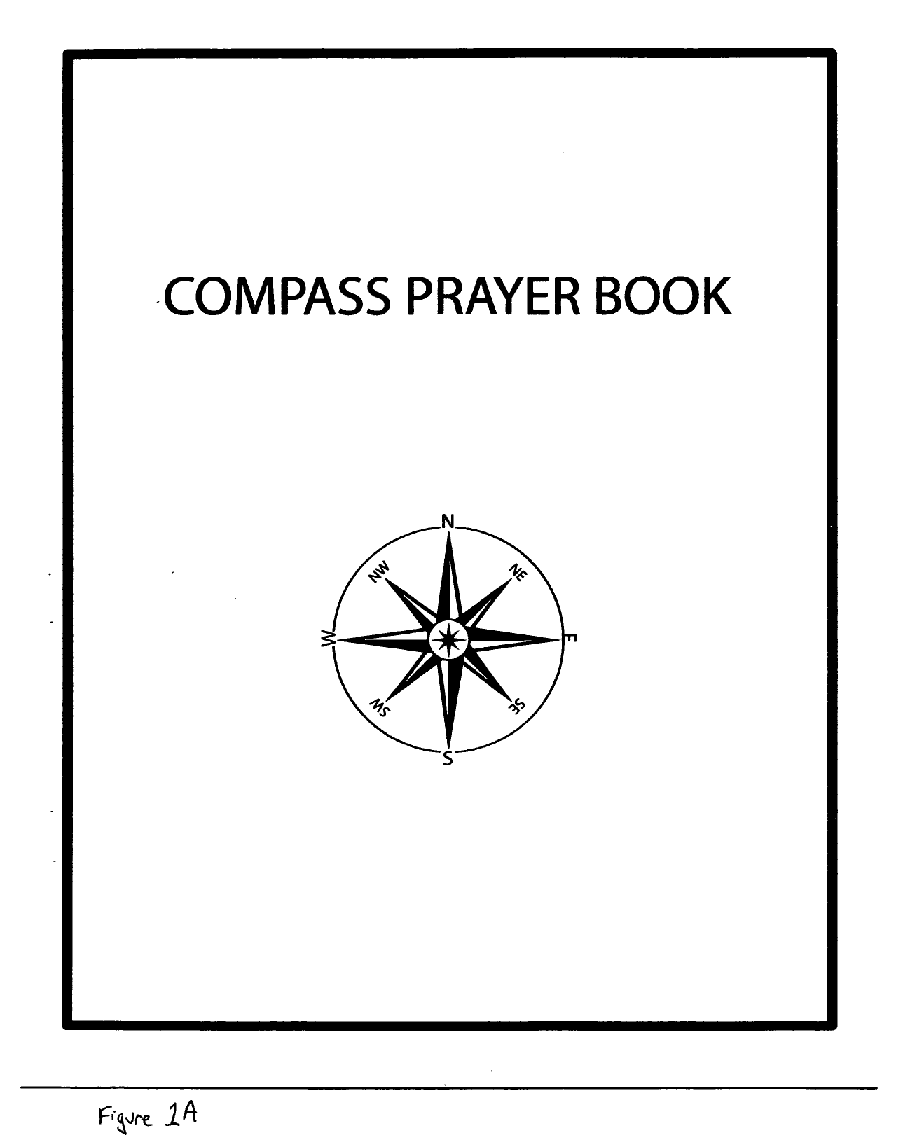

FIG. 1B: Compass Prayer Book. A prayer book, in Hebrew, with a compass embedded in the book's front cover. Compass may be embedded in any part of the Compass Prayer Book.

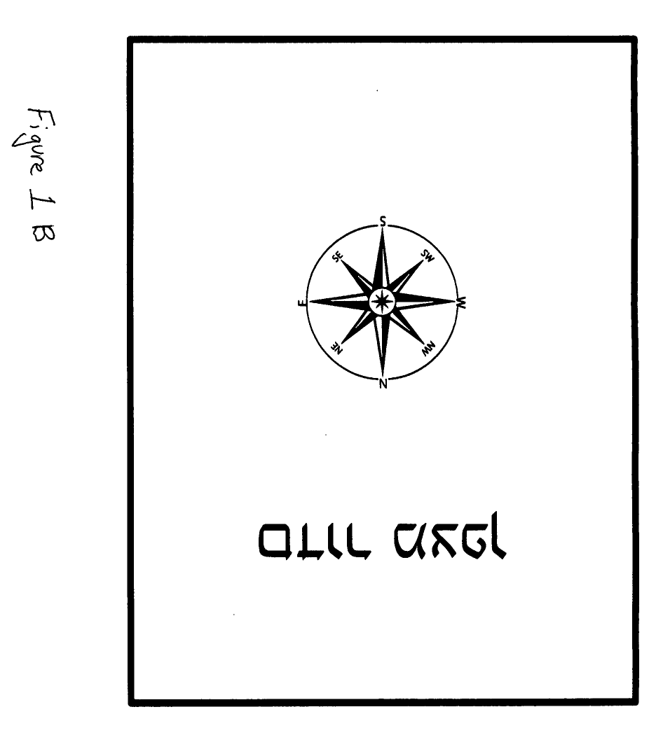

FIG. 1C: Compass Prayer Book. A prayer book, in Arabic, with a Compass embedded in the book's front cover. Compass may be embedded in any part of the Compass Prayer Book. (Figure not included in this initial application).

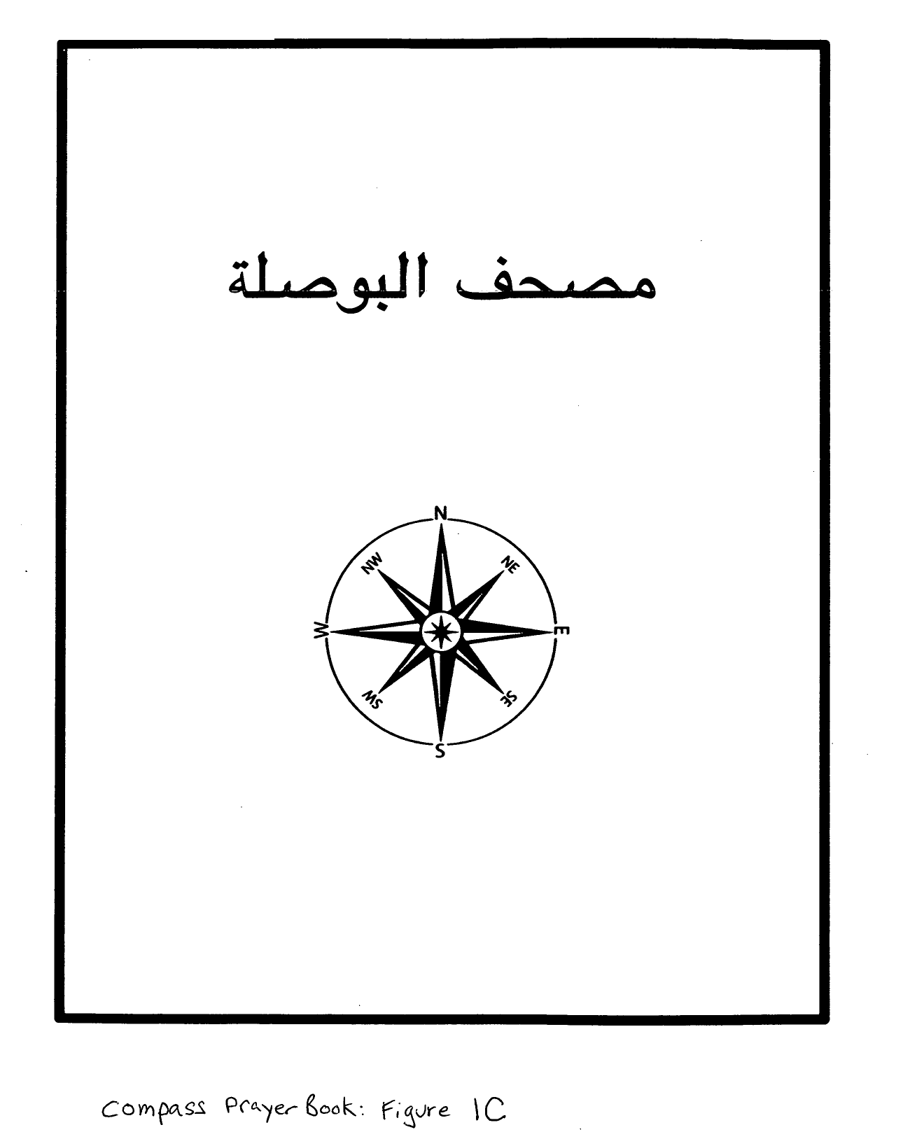

Note: These drawings depict examples of the Compass Prayer Book, but are not sole representations of this invention. Compass Prayer Book may be in any language and any type of directional device, including a compass, may be embedded in any part of the book. Moreover, the Compass Prayer Book need not be a prayer book at all, but may be a book with a Compass embedded to satisfy the needs of the secular and nonreligious reader with regards to direction that one wishes to face. In addition, other religions, not hereto mentioned, may and can find the Compass Prayer Book, an invention, designed to satisfy their distinctive needs.

The Compass in these drawings depicts a compass, but for purposes of the Compass Prayer Book, any directional devise embedded in a book suffices in achieving the goals that this invention has achieved for its users.

### DETAILED DESCRIPTION OF THE INVENTION

The Compass Prayer Book is an invention which allows a reader to have a book as well as a directional device to determine the direction he or she wishes to face while reading. Using one entity, a book combined with a directional device, most commonly a compass, are joined as one entity in achieving this purpose. Casual observers and active participants have often observed or partaken in the challenge of determining what direction to face while reading. For certain religious adherences, as examples, but not limited to, Jewish and Muslim faiths, readers of scriptures, prayers and other ecclesiastical literature, have found it difficult to precisely determine the direction for them to read that is required by their faith. What is old is having no direction, having to guess and therefore not adhering strictly to the law of their faith as the reader would like, and is required by their faith. What is new is the available, easy, conjoined availability of having a directional device embedded in one's book, to, with certainty, determine the direction one wishes to face while reading the book.

In a more general way, for those secular readers, what is old is positioning oneself for maximum light, for tanning while reading, for reading while blocking oneself from the sun, for determining sunrises and sunsets direction, and other uses not mentioned, the Compass Prayer Book, a new concept, entity, and invention, enables a user, and guarantees that user, to have both the book and the directional device, always at hand, in satisfying oneself by reading facing the desired direction.

The manufacture of the Compass Prayer Book, is a book where the directional device, more often a Compass, is embedded in a front or back cover, on either side, or within the text, of the book itself, therefore becoming a Compass Prayer Book.

The directional device can be embedded into the book in any manner which enables the directional device to be securely attached to the book.

1. The Compass Prayer Book is the first and only invention combining a compass and a book into one greater entity. The inventor claims the Compass Prayer Book to be the first and only of its kind. The inventor claims the Compass Prayer Book to be the only unique invention that enables a reader to determine the direction one wishes to face while reading. The inventor claims the invention of combing a book with a directional device attached. The inventor claims that certain religious groups will find the Compass Prayer Book tremendously valuable in determining direction for reading ones prayer book. The inventor claims to be the original and first inventor of the Compass Prayer Book. The inventor claims to be the original and first to design, put forth, draw, have drawn, describe, the Compass Prayer Book.
